(19) United States
(12) Patent Application Publication
(10) Pub. No.: US 2018/0205186 A1
(43) Pub. Date: Jul. 19, 2018

(54) ELECTRICAL CONNECTOR HAVING TWO ROWS OF CONTACTS EACH CONSISTING OF ONE GROUND CONTACT AND ONE POWER CONTACT

(71) Applicant: FOXCONN INTERCONNECT TECHNOLOGY LIMITED, Grand Cayman (KY)

(72) Inventor: JUN ZHAO, HuaiAn (CN)

(21) Appl. No.: 15/873,159

(22) Filed: Jan. 17, 2018

(30) Foreign Application Priority Data
Jan. 17, 2017 (CN) 201720060126.7

(51) Int. Cl. H01R 13/6594; H01R 13/64; H01R 12/71; H01R 24/62; H01R 13/6582; H01R 13/502; H01R 13/26; H01R 12/70; H01R 107/00

(52) U.S. Cl. CPC H01R 13/6594; H01R 13/64; H01R 12/712; H01R 24/62; H01R 2107/00; H01R 13/502; H01R 13/26; H01R 12/707; H01R 13/6582

(57) ABSTRACT

An electrical connector includes: an insulative housing having a base and a tongue; an upper and lower rows of contacts secured in the insulative housing and exposed to two opposite surfaces of the tongue; a pair of grounding pieces separated from each other and mounted in the insulative housing between the upper row of contacts and the lower row of contacts; a shielding shell enclosing the insulative housing, wherein each row of the upper and lower rows of contacts consist of one outermost ground contact and one power contact.

### BACKGROUND OF THE INVENTION

### 1. Field of the Invention

The present invention relates to an electrical connector having two rows of contacts and a pair of separated grounding pieces between the two rows of contacts, wherein each row of the two rows of contacts consist of one ground contact and one power contact for ease of manufacturing at low cost for specific applications such as for charging purposes only.

### 2. Description of Related Arts

China Patent No. 203859265 discloses an electrical connector supporting dual-orientation mating, comprising an upper and lower rows of contacts, wherein each row of the two rows of contacts include two outermost ground contacts and two power contacts.

China Patent Application Publication No. 105680246 discloses a dual-orientation electrical connector comprising two rows of contacts and a pair of grounding pieces separated from each other between the two rows of contacts. Each row of contacts need not be full-fledged, as is known in this art, e.g., in U.S. Patent Application Publication No. 2016/0372870.

### SUMMARY OF THE INVENTION

An electrical connector comprises: an insulative housing having a base and a tongue; an upper and lower rows of contacts secured in the insulative housing and exposed to two opposite surfaces of the tongue; a pair of grounding pieces separated from each other and mounted in the insulative housing between the upper row of contacts and the lower row of contacts; a shielding shell enclosing the insulative housing, wherein each row of the upper and lower rows of contacts consist of one outermost ground contact and one power contact.

### BRIEF DESCRIPTION OF THE DRAWING

FIG. 1 is a front perspective view of an electrical connector in accordance with the present invention;

FIG. 2 is a rear perspective view of the electrical connector;

FIG. 3 is an exploded view of the electrical connector;

FIG. 4 is an exploded view from a different perspective;

FIG. 5 is an exploded view showing part of a contact module of the electrical connector;

FIG. 6 is an exploded view showing an upper and lower rows of contacts and a pair of grounding pieces of the contact module of the electrical connector;

FIG. 7 is a cross-sectional view of the electrical connector taken along line A-A in FIG. 1; and

FIG. 8 is a schematic table showing contact positions of the electrical connector.

### DETAILED DESCRIPTION OF THE PREFERRED EMBODIMENT

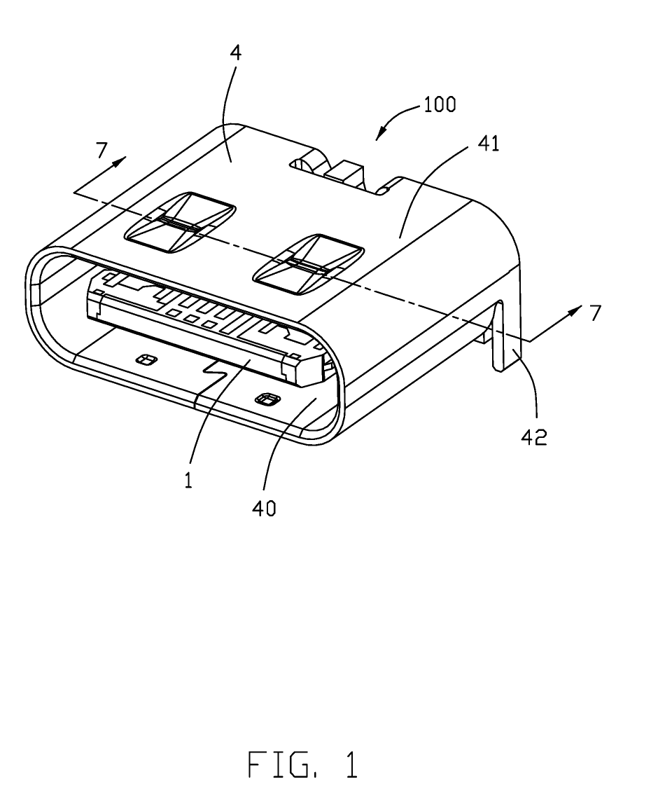

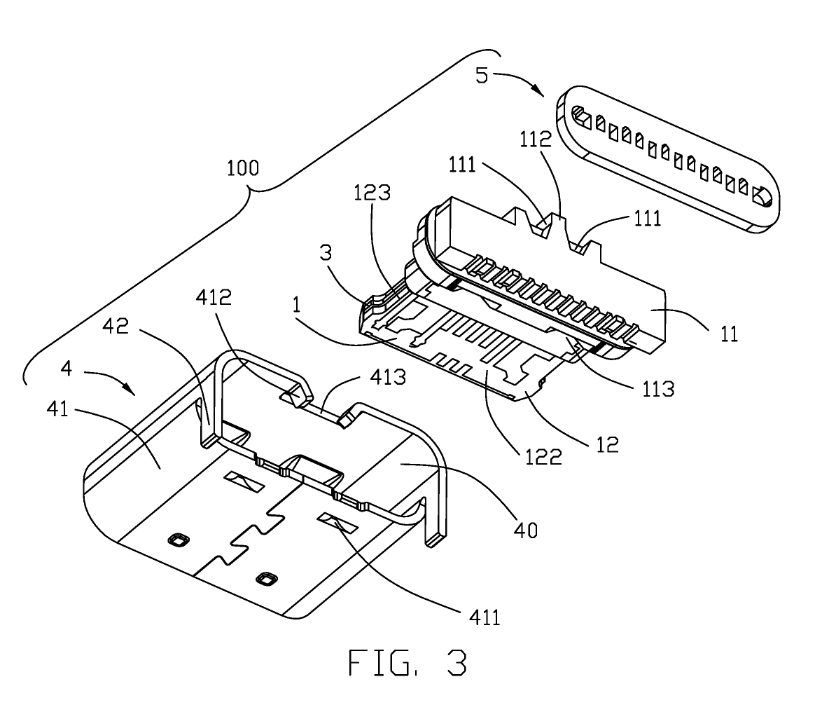

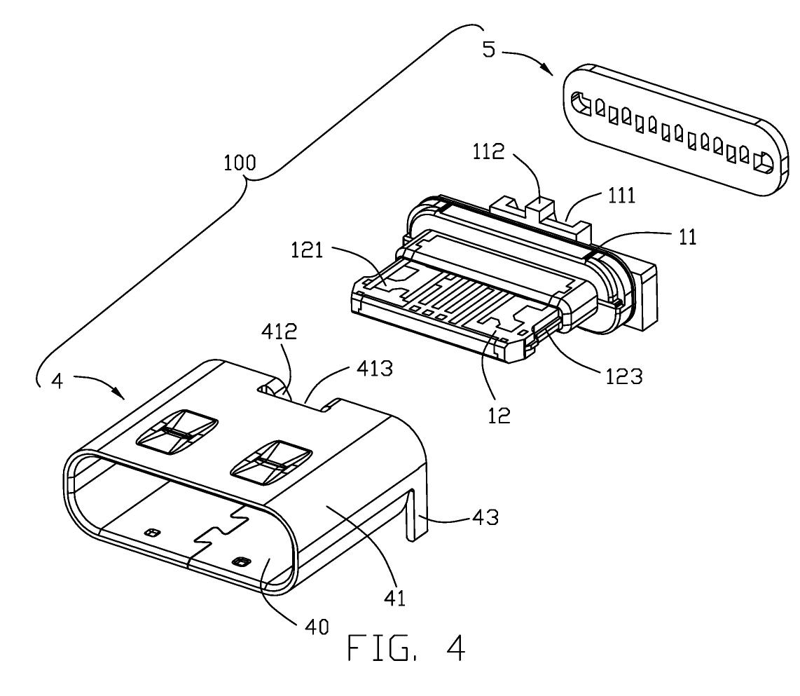

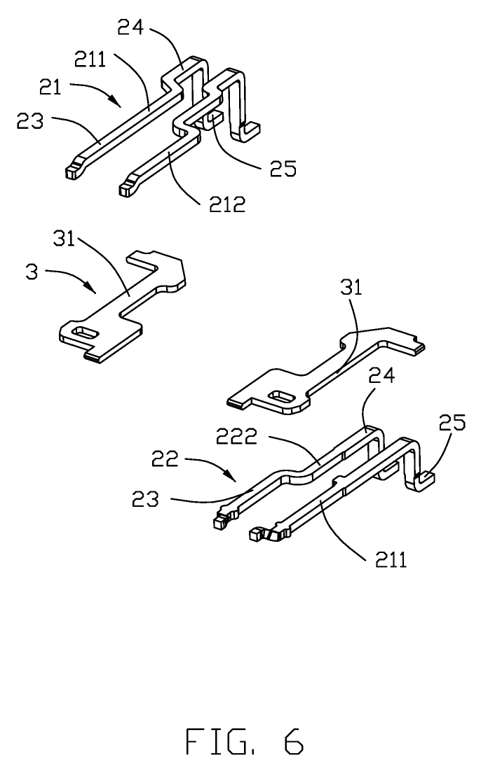

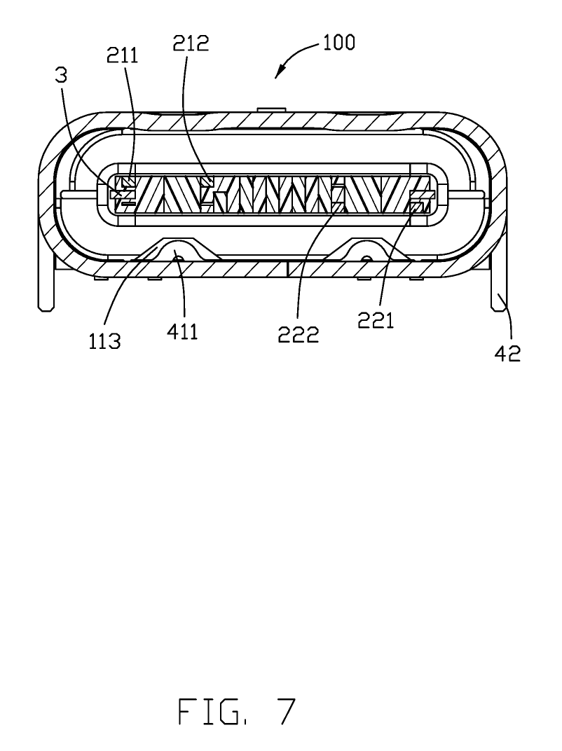

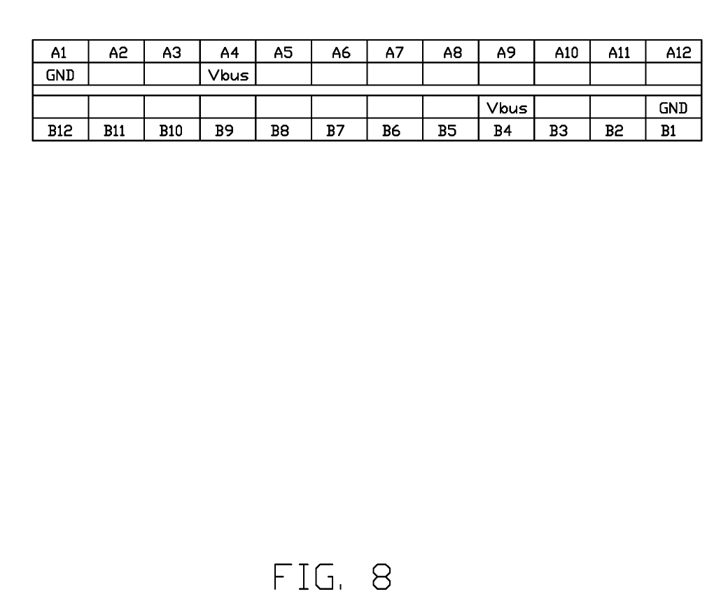

Referring to FIGS. 1 to 8, an electrical connector 100 comprises an insulative housing 1, two rows of contacts 2 secured in the insulative housing 1, a pair of grounding pieces 3 separated from each other and mounted in the insulative housing 1 between the two rows of contacts 2, and a shielding shell 4 having a receiving space 40 and enclosing the insulative housing 1. The insulative housing 1, the contacts 2, and the grounding pieces 3 constitute a contact module.

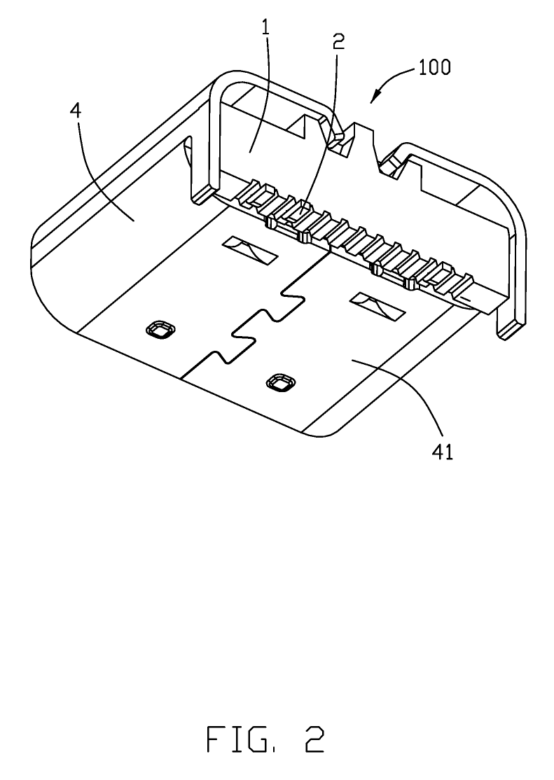

Referring to FIGS. 2-5, the insulative housing 1 has a base 11 and a tongue 12. The base 11 has a pair of rear slots 111, a protrusion 112, and a pair of front slots 113. The tongue 12 has opposite first and second surfaces 121 and 122 and a pair of side notches 123.

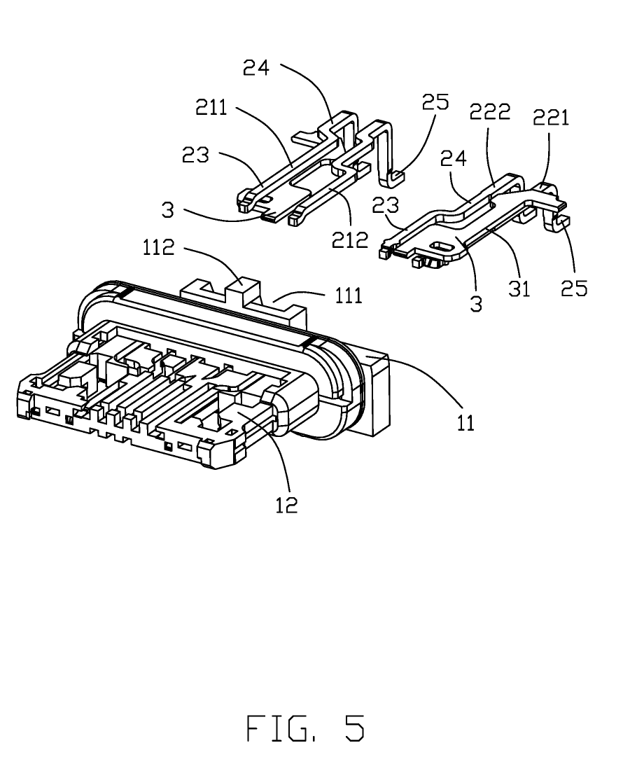

Referring to FIGS. 5-8, the contacts 2 include an upper row of contacts 21 and a lower row of contacts 22. Each row of the upper and lower rows of contacts 21 and 22 consist of one outermost ground contact and one power contact, i.e., retaining only two (2) contacts (the first contact and the fourth contact) out of a total of twelve contacts in conformity with USB Type-C standard while omitting the other ten (10) contacts. Each contact 2 has a contacting portion 23, a soldering portion 25, and an intermediate connecting portion 24. The soldering portions 25 of the upper and lower contacts 21 and 22 are aligned in one line. The upper row of contacts 21 consist of one outermost ground contact 211 and one power contact 212 next to and inwardly of the ground contact 211; the lower row of contacts 22 consist of one outermost ground contact 221 and one power contact 222 next to and inwardly of the ground contact 221. A distance between the contacting portions 23 of the ground contact 211 and the power contact 212 is greater than a distance between the connecting portions 24 thereof for large current conduction.

Referring again to FIG. 5, the pair of grounding/locking pieces 3 are insert molded together with the contacts 2 simultaneously in one shot. The grounding piece 3 has a side portion 31 exposed to the notch 123. The grounding piece 3 may have a portion in contact with an inner wall of the shielding shell 4. Or, the grounding piece 3 may be in contact with a corresponding ground contact 211 or 221.

Referring to FIGS. 1-4, the shielding shell 4 has a main part 41, a pair of front stops 411 at a bottom wall of the main part 41, a pair of rear stops 412, and a limiting slot 413, and a pair of soldering legs 42. Notably, in the invention the contacts 2 and the grounding pieces 3 are both integrally formed with the first stage housing via an initial/single insert-molding process, and successively further integrally formed within a second stage housing via another insert-molding or overmolding process to complete the complete configuration of the housing.

What is claimed is:

1. An electrical connector comprising:
an insulative housing having a base and a tongue;
an upper and lower rows of contacts secured in the insulative housing and exposed to two opposite surfaces of the tongue;
a pair of grounding pieces separated from each other and mounted in the insulative housing between the upper row of contacts and the lower row of contacts;
a shielding shell enclosing the insulative housing; wherein
each row of the upper and lower rows of contacts consist of one outermost ground contact and one power contact.

2. The electrical connector as claimed in claim 1, wherein all the contacts and the grounding pieces are insert molded simultaneously.

3. The electrical connector as claimed in claim 1, wherein the shielding shell is in contact with the pair of grounding pieces.

4. The electrical connector as claimed in claim 1, wherein each ground contact is in contact with a corresponding grounding piece.

5. An electrical connector comprising:
a contact module enclosed within a metallic shielding shell and including a plurality of contacts arranged in two rows, a pair of metallic grounding/locking pieces located between the two rows in the vertical direction, all said contacts and said pair of grounding/locking pieces being integrally formed within an insulative housing via an initial single shot insert-molding process, said housing including a base and a tongue portion extending forwardly from the base along a front-to-back direction perpendicular to said vertical direction, wherein
said contacts include only one pair of grounding contacts at opposite outermost positions in a transverse direction perpendicular to both said vertical direction and said front-to-back direction, and only one pair of power contacts located at opposite inner positions between said pair of grounding contacts in the transverse direction; wherein
each row has one grounding contact and one power contact which are both located on a same side with regard to a front-to-back centerline of the housing.

6. The electrical connector as claimed in claim 5, wherein said contacts only include said pair of grounding contacts and said pair of power contacts.

7. The electrical connector as claimed in claim 5, wherein the shielding shell is in contact with the pair of grounding pieces.

8. The electrical connector as claimed in claim 5, wherein each ground contact is in contact with a corresponding grounding piece.
